(19) United States
(12) Patent Application Publication
(10) Pub. No.: US 2016/0101648 A1
(43) Pub. Date: Apr. 14, 2016

(54) REMOVABLY ATTACHABLE SKATEBOARD WHEEL COVERS

(71) Applicant: Lawrence Edwards, Bakersfield, CA (US)

(72) Inventor: Lawrence Edwards, Bakersfield, CA (US)

(21) Appl. No.: 14/882,260

(22) Filed: Oct. 13, 2015

Related U.S. Application Data
(60) Provisional application No. 62/062,774, filed on Oct. 10, 2014.

(51) Int. Cl. B60B 7/06

(52) U.S. Cl. CPC B60B 7/06; B60B 2900/572

(57) ABSTRACT

A removably attachable wheel cover for attaching to the wheels of a conventional skateboard having bolted wheels includes a decorative sidewall cover having a decorative side and an attachment side defined by a substantially flat, smooth surface that includes a securing slot and a plurality of adhesive portions. The decorative sidewall cover is secured to the bolted wheel through both a nylon rope tether and the engagement of the adhesive portions with the sidewall surface of the wheel. In some wheel configurations, the attachment side will be positioned flush against a target wheel while in wheel configurations where the connecting bolt extends beyond the profile of the wheel, it is contemplated that the adhesive portions will include extension members which extend the adhesive surface of the adhesive portions to the sidewall surface of the wheel without requiring the attachment side to be positioned flush against a target wheel.

### CROSS REFERENCE TO RELATED APPLICATIONS

This application claims the benefit of, and incorporates by reference co-pending U.S. provisional patent application Ser. No. 62/062,774, filed Oct. 10, 2014.

### BACKGROUND OF THE INVENTION

1. Field of the Invention

This invention relates generally to wheel attachments and, more particularly, to a removably attachable, designed wheel cover for a skateboard.

2. Description of the Prior Art

The use and design of skateboards is well known. A problem which still exists, however, is that conventional skateboard wheels lack design elements that enable similar boards to be distinguished or to allow for increased personalization. Thus, there remains a need for removably attachable wheel covers for skateboards that enable a user to attach desired illustrative designs to the wheels of a skateboard. It would be helpful if such removably attachable wheel covers included a decorative sidewall cover that attached to wheels without disturbing the balance and functionality of the wheel. It would be additionally desirable for such removably attachable wheel covers to employ a two distinct attachment mechanisms to securely lock the covers in place while allowing them to be detached when desired.

The Applicant's invention described herein provides for removably attachable wheel covers adapted to fasten over the wheels of a skateboard and enable decorative customization. The primary component of each of Applicant's removably attachable wheel covers is a decorative sidewall cover having tether attachment system and an adhesive attachment system. When in operation, the removably attachable wheel covers enable a user to customize the sidewall illustrations and decorations of the wheel. As a result, many of the limitations imposed by prior art structures are removed.

### SUMMARY OF THE INVENTION

A removably attachable wheel cover for attaching to the wheels of a conventional skateboard having bolted wheels. The removably attachable wheel cover comprises a decorative sidewall cover having a decorative side defined by a smooth or textured surface that includes decorative indicia and/or attachments and an attachment side defined by a substantially flat, smooth surface that includes a securing slot and a plurality of adhesive portions. The decorative sidewall cover is secured to the bolted wheel through both a nylon rope tether and the engagement of the adhesive portions with the sidewall surface of the wheel. In some wheel configurations, the attachment side will be positioned flush against a target wheel. In wheel configurations where the bolt which connects a target wheel extends beyond the profile of the wheel, it is contemplated that the adhesive portions will include extension members which extend the adhesive surface of the adhesive portions to the sidewall surface of the wheel without requiring the attachment side to be positioned flush against a target wheel.

It is an object of this invention to provide removably attachable wheel covers for skateboards that enable a user to attach desired illustrative designs to the wheels of a skateboard.

It is another object of this invention to provide removably attachable wheel covers which include a decorative sidewall cover that attached to wheels without disturbing the balance and functionality of the wheel.

It is yet another object of this invention to provide removably attachable wheel covers which employ a two distinct attachment mechanisms to securely lock the covers in place while allowing them to be detached when desired.

These and other objects will be apparent to one of skill in the art.

### BRIEF DESCRIPTION OF THE DRAWINGS

FIG. 1 is a side elevational view of a removably attachable wheel covers built in accordance with the present invention disposed on a skateboard.

FIG. 2 is an elevational view of the back of a single removably attachable wheel cover built in accordance with the present invention tethered to a skateboard wheel.

FIG. 3A is an side cross-sectional view of the a single removably attachable wheel cover built in accordance with the present invention tethered to a skateboard wheel with a recessed fastening bolt.

FIG. 3B is an side cross-sectional view of the a single removably attachable wheel cover built in accordance with the present invention tethered to a skateboard wheel with a extended fastening bolt.

### DETAILED DESCRIPTION OF THE INVENTION

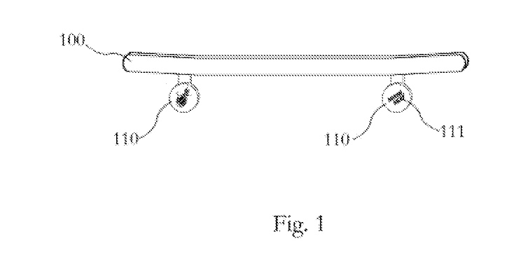

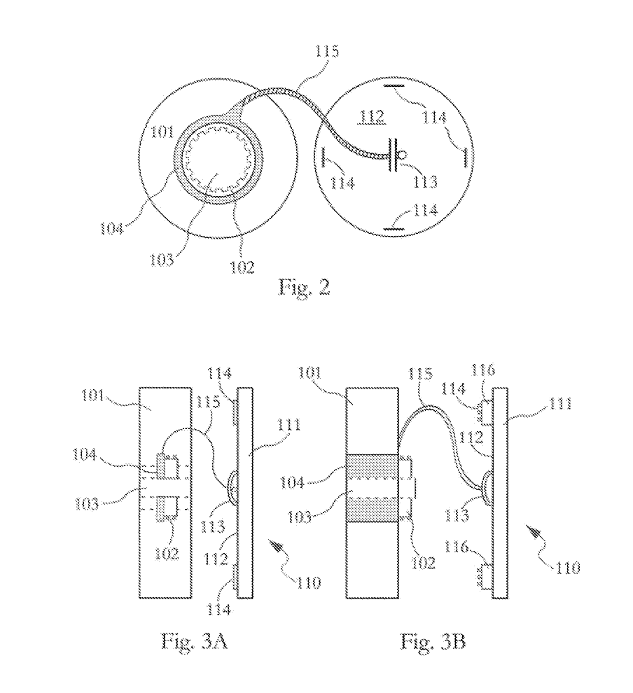

Referring now to the drawings and in particular FIGS. 1, 2, 3A and 3B, a removably attachable wheel cover 100 for attaching to a conventional skateboard having bolted wheels 101 is shown as a decorative sidewall cover 110 having a decorative side 111 and an attachment side 112. The decorative side 111 is defined by a smooth or textured surface that includes decorative indicia and/or attachments. The attachment side 112 is a substantially flat, smooth surface that includes a securing slot 113 and four adhesive portions 114.

The decorative sidewall cover 110 is secured to the bolted wheel 101 through a nylon rope 115 that is fastened to the wheel 101 beneath the bolt 102 of the wheel 101 and through the engagement of the adhesive portions 114 with the sidewall surface of the wheel 101. In this regard, it is contemplated that when the wheel 101 is secured to the axle 103 of the skateboard 100, the nylon rope 115 will secured either to a bearing 104 in place on the axle 103 or adjacent to a bearing 104 in place on the axle 103. Then, the bolt 102 will be screwed over the axle 103, thereby securing the nylon rope 115 to the axle 103 either through its connection to the bearing 104 or wedged in between the bearing 104 and the bolt 102. The other end of the nylon rope 115 is then passed through the securing slot 113 on the attachment side 112 of the sidewall cover 110 and knotted so that it is held there by preventing it from sliding back through the securing slot 113.

Once the nylon rope 115 is in place to tether the sidewall cover 110 to the wheel 101, the attachment side 112 of the sidewall cover 110 is pressed against the sidewall of the wheel 101, causing the adhesive portions 114 to adhere to the wheel 101.

In wheel 101 configurations where the bolt 102 extends beyond the wheel 101, it is contemplated that the adhesive portions 114 will include extension members 116 which enable the adhesive surface of the adhesive portions 114 to extend to the sidewall surface of the wheel 101, thereby enabling the adhesive portions 114 to adhere to the wheel 101.

It is contemplated that the sidewall cover 110 is sized to completely cover the visible side of the target skateboard wheel, but does not contact the ground while the skateboard is in use. In the preferred embodiment, the sidewall cover 110 is constructed of hard plastic or stainless steel. It is contemplated that depending on the size of the target skateboard wheel, the sidewall cover 110 can be constructed to measure between one (1) and ten (10) inches in diameter.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A decorative wheel cover for attaching to a target wheel of a conventional skateboard, comprising:
a sidewall cover having a front side and an opposing back side, wherein said sidewall cover is sized to cover one sidewall of a target skateboard wheel; and
said back side including a first attachment system adapted to secure the sidewall cover to an axle connected to the target skateboard wheel and a second attachment system adapted to secure the sidewall cover to a sidewall of the target wheel.

2. The decorative wheel cover of claim 1, wherein said sidewall cover is sized such that it fully covers one sidewall of a target skateboard wheel without extending beyond any edge of the sidewall being covered.

3. The decorative wheel cover of claim 1, wherein said first attachment system and second attachment system are each operative to removably secure said sidewall cover to the target skateboard wheel.

4. The decorative wheel cover of claim 1, wherein:
said first attachment system includes an elongated rope adapted to attach to an axle connected to the target skateboard wheel at a first end and to the back side at a second end opposite the first end; and
said back side is configured to receive and retain the second end of the elongated rope.

5. The decorative wheel cover of claim 4, wherein said back side includes a securing slot integrated therewith, thereby configuring the back side to receive and retain the second end of the elongated rope.

6. The decorative wheel cover of claim 4, additionally comprising a bearing attached to said elongated rope at the first end, wherein said bearing is positioned on the axle connected to the target skateboard wheel, thereby enabling the first attachment system to secure the sidewall cover to the axle through a tether mechanism.

7. The decorative wheel cover of claim 1, wherein the second attachment system is defined by at least one adhesive portion the integrated with the back side and operative to adhere to sidewall of the target wheel.

8. The decorative wheel cover of claim 7, wherein said at least one adhesive portion is positioned on the surface of the back side.

9. The decorative wheel cover of claim 7, additionally comprising an extension member integrated with each of said at least one adhesive portion, wherein each of said extension members is operative to lift the adhesive portion with which it is integrated off of the surface of the back side.

10. A decorative wheel cover for attaching to a target wheel of a conventional skateboard, comprising:
a sidewall cover having a front side and an opposing back side, wherein said sidewall cover is sized to cover one sidewall of a target skateboard wheel;
an elongated rope adapted to attach to an axle connected to the target skateboard wheel at a first end and to the back side at a second end opposite the first end; and
at least one mechanical fastening surface integral with the back side, wherein said at least one mechanical fastening surface is configured to attach to a sidewall of the target wheel.

11. The decorative wheel cover of claim 10, wherein said sidewall cover is sized such that it fully covers one sidewall of a target skateboard wheel without extending beyond any edge of the sidewall being covered.

12. The decorative wheel cover of claim 10, wherein said back side is adapted to receive and retain the second end.

14. The decorative wheel cover of claim 12, wherein said back side includes a securing slot integrated therewith, thereby adapting the back side to receive and retain the second end.

15. The decorative wheel cover of claim 10, additionally comprising a bearing attached to said first end of the elongated rope, wherein said bearing is positioned on the axle connected to the target skateboard wheel, thereby enabling the elongated rope to secure to attach to the axle through a tether mechanism.

15. The decorative wheel cover of claim 10, wherein the at least one mechanical fastening surface is defined by at least one adhesive portion the integrated with the back side and operative to adhere to sidewall of the target wheel.

16. The decorative wheel cover of claim 15, wherein said at least one adhesive portion is positioned on the surface of the back side.

17. The decorative wheel cover of claim 15, additionally comprising an extension member integrated with each of said at least one adhesive portion, wherein each of said extension members is operative to lift the adhesive portion with which it is integrated off of the surface of the back side.

18. The decorative wheel cover of claim 10, wherein said at least one mechanical fastening surface is positioned on the surface of the back side.

19. The decorative wheel cover of claim 10, additionally comprising an extension member integrated with each of said at least one mechanical fastening surface, wherein each of said extension members is operative to lift the mechanical fastening surface with which it is integrated off of the surface of the back side.

20. A decorative wheel cover for attaching to a target wheel of a conventional skateboard, comprising:
a sidewall cover having a front side and an opposing back side, wherein said sidewall cover is sized to cover one sidewall of a target skateboard wheel;
an elongated rope adapted to attach to an axle connected to the target skateboard wheel at a first end and to the back side at a second end opposite the first end, wherein said back side includes a securing slot integrated therewith which adapts the back side to receive and retain the second end;
at least one mechanical fastening surface integral with the back side, wherein said at least one mechanical fastening surface is configured to attach to a sidewall of the target wheel; and
a bearing attached to said first end of the elongated rope, wherein said bearing is positioned on the axle connected to the target skateboard wheel, thereby enabling the elongated rope to secure to attach to the axle through a tether mechanism.
